(19) United States
(12) Patent Application Publication
(10) Pub. No.: US 2026/0115741 A1
(43) Pub. Date: Apr. 30, 2026

(54) Air Mixing Shower Head

(71) Applicant: Redpoint Co.,Ltd., Gwangju (KR)

(72) Inventor: Tae Seong Ahn, Gwangju (KR)

(21) Appl. No.: 18/932,685

(22) Filed: Oct. 31, 2024

(51) Int. Cl. B05B 1/18; B05B 7/04

(52) U.S. Cl. CPC B05B 1/185; B05B 7/0416

(57) ABSTRACT

The present invention relates to a showerhead that allows air to be introduced into the interior of the shower hose through an inlet hole, where it is mixed with water and sprayed through the nozzle, providing a massaging effect. More specifically, the water mixed with air flows as a vortex guided by the conduit guide fin in the grip tube and the head guide fin in the head unit. As time passes, some of the air mixed with water gradually accumulates in the pocket chamber, enabling the user to observe the accumulated air pocket, thereby helping them conserve water during showers.

### TECHNICAL FIELD

The present invention relates to a showerhead that allows air to be introduced into the interior of the shower hose through an inlet hole, where it is mixed with water and sprayed through the nozzle, providing a massaging effect. More specifically, the water mixed with air flows as a vortex guided by the conduit guide fin in the grip tube and the head guide fin in the head unit. As time passes, some of the air mixed with water gradually accumulates in the pocket chamber, enabling the user to observe the accumulated air pocket, thereby helping them conserve water during showers.

### BACKGROUND ART

Generally, a showerhead is a spray device designed to release cold or warm water, widely used in bathrooms, sinks, bathtubs, body showers, water pools, and water softeners.

Commonly used showerheads are installed in bathrooms, with the nozzle, similar to a sprinkler, positioned above head height and integrated with the handle where water is discharged. When the faucet is turned, either cold or warm water is released, allowing for a quick wash, which is often referred to as a shower. Consequently, due to the busy lifestyles of modern people, many prefer a quick shower over a bath.

Traditionally, the nozzles of showerheads installed in detached houses or apartment bathrooms were mostly fixed, but nowadays, handheld showerheads that allow users to move them freely while holding them have become more common. As a result, users have developed a closer interaction with the showerhead, leading to a demand for various types of showerheads with additional functions beyond merely spraying water.

As an example, the water sprayed from the showerhead that directly contacts the body may also include a massaging function, which can promote blood circulation and improve skin health during the washing process.

To achieve this, air is drawn into the showerhead before the water is sprayed, where it is dissolved and mixed with the water, allowing the water mixed with air to be sprayed, providing a refreshing impact on the body.

Additionally, as the air mixes with the water inside the showerhead, it forms ultra-fine bubbles smaller than skin pores, penetrating deeply into the skin to provide moisture, thoroughly cleansing impurities and residues from within the pores, and exfoliating dead skin cells from the scalp and skin surface due to the micro-vibrations generated by the bubbles

This process reduces the use of various cleansers and detergents, such as shampoo, soap, and body cleaner, while effectively removing impurities and residues within the pores, alleviating itching caused by skin conditions, supplying oxygen to the dermal layer to revitalize skin tissue, and generating negative ions through the Lenard effect, which helps with fatigue recovery and enhances skin beauty.

In a general conventional art, a multifunctional microbubble water-saving showerhead that forcefully mixes air into commonly used fluids such as tap water (hereinafter referred to as "fluid") to create microbubble water rich in negative ions and bubbles (air and dissolved oxygen), and allows the addition of phytoncide or fragrances. However, the implementation of such a system has posed challenges, including the cost associated with equipping and installing a separate air injection device to forcefully draw air into the showerhead’s internal space, as well as the issue of securing sufficient installation space.

Furthermore, it is difficult for users to intuitively check how much water is being used while showering, which does not assist in efforts to conserve water, leading users to rely solely on their instincts.

Therefore, there is a growing need for the development of a showerhead that can introduce air, mix it with water, and provide a refreshing impact on the user’s body for a massaging effect, while also allowing users to intuitively monitor their water usage, thereby aiding their efforts to conserve water.

### SUMMARY

The purpose of the present invention is to provide an air-mixing showerhead that introduces air into the interior of the shower hose through an inlet hole, where the flow is formed into a vortex by the conduit guide fin in the grip tube and the head guide fin in the head unit, promoting the mixing of air and water to create air bubbles, which are then sprayed from the head unit, providing a gentle impact on the skin.

Another objective of the invention is to maintain cleanliness by suppressing the accumulation of impurities and foreign substances inside the grip tube as the water flows in a vortex guided by the conduit guide fin, while the head guide fin ensures that the water flows in a swirling motion, preventing air from concentrating on certain nozzles of the spray plate and allowing for effective air flushing.

Additionally, another objective of the invention is to provide an air-mixing showerhead where water and air entering the shower hose through the inlet hole flow into the pocket chamber, and as the top of the pocket chamber is sealed, the water moves downward, leaving only the air to form an air pocket, which gradually increases in size over time, enabling the user to visually monitor the size of the air pocket and intuitively gauge water usage.

Another objective of the present invention is to provide an air-mixing showerhead that, when water is sprayed from the front of the head unit, uses an air flow passage formed through the center of the head unit, connecting the front and rear, to draw air from the rear side of the head unit to the front, directing it in the same direction as the water spray.

Additionally, another objective of the invention is to provide an air-mixing showerhead where the cross-section of the grip tube, held by the user, is formed in an elliptical shape to offer superior grip comfort, and the internal water conduit is formed in a circular shape, separated from the grip tube and the pocket chamber, allowing the water to flow smoothly.

To achieve the above objectives, the present invention provides a showerhead where air is introduced into the interior of the shower hose (20) through an inlet hole (21). The grip tube (100) is equipped with a coupling hole (140) at its lower end, which connects to the shower hose (20). Inside this coupling hole (140), a conduit guide fin (130) is positioned to create a vortex flow of the water passing through the interior; and the head unit (200) is formed as a hollow circular structure, connected to the grip tube (100), and contains a connecting port (210) that receives water from the interior of the grip tube (100). The head unit is also equipped with a spray plate (240) at the front, which has nozzles (241) for spraying the air-mixed water; additionally, at the center of the head unit (200), an air flow passage (230) is formed, with the sides sealed while the front and rear remain open. This allows air from the rear side of the head unit (200) to move to the front as water is sprayed through the nozzle (241). Consequently, the air passing through the grip tube (100) and the air passing through the air flow passage (230) mix at the front of the head unit (200).

Additionally, at the rear end of the connecting port (210) in the present invention, a curved, partition-shaped head guide fin (220) is formed. The water that collides with the head guide fin (220) flows circumferentially within the head unit (200). [0023] and, the internal space of the grip tube (100) in the present invention includes the central chamber (111), which is the internal space of the water conduit (110) vertically positioned within the grip tube (100). The central chamber is open at the bottom, connecting with the coupling hole (140), and open at the top, linking to the head unit (200); and the pocket chamber (120) is formed as the space between the inner surface of the grip tube (100) and the water conduit (110). It is open at the bottom, connecting with the coupling hole (140), and sealed at the top.

Additionally, the air-mixed water in the present invention passes through the coupling hole (140) and branches into the central chamber (111) and the pocket chamber (120); As some of the water entering the pocket chamber (120) flows downwards to the lower part of the pocket chamber (120), an air pocket (121) remains at the top of the pocket chamber (120). The vertical length of the air pocket (121) gradually increases over time as water enters the grip tube (100), causing the water level within the pocket chamber (120) to lower.

Additionally, the grip tube (100) in the present invention is made of a transparent material, allowing the water level inside the pocket chamber (120) to be visible. At a specific height on the grip tube (100), one or more water usage indicators (150) are marked.

Additionally, the cross-section of the grip tube (100) in the present invention is formed in an elliptical shape, while the water conduit (110), which is spaced apart from the grip tube (100) with the pocket chamber (120) in between, has a perfectly circular cross-section.

Additionally, the diameter of the vortex created by the fluid inside the head unit (200) in the present invention is larger than the diameter of the vortex created by the fluid inside the grip tube (100).

Additionally, the present invention includes an air control ring (160) positioned to seal the open lower end of the pocket chamber (120). The air control ring (160) features a central hole (161) that corresponds to the water conduit (110), a large hole (162) for the fluid to enter and exit the pocket chamber, and a smaller hole (163) with a diameter smaller than that of the large hole (162).

### ADVANTAGEOUS EFFECTS

The air-mixing showerhead according to the present invention allows air to be introduced into the shower hose through an inlet hole. The flow is shaped into a vortex by the conduit guide fin formed in the grip tube and the head guide fin formed in the head unit, promoting the mixing of air and water to create air bubbles. These bubbles are then sprayed from the head unit, providing a gentle impact on the skin.

Additionally, the present invention maintains cleanliness by suppressing the accumulation of impurities and foreign substances inside the grip tube as the water flows in a vortex guided by the conduit guide fin. The head guide fin helps direct the water in a swirling motion, preventing air from concentrating in specific nozzles of the spray plate and allowing for effective air flushing.

Additionally, in the present invention, water and air enter the pocket chamber through the inlet hole into the shower hose. As the top of the pocket chamber is sealed, the water flows downward while only the air remains, forming an air pocket. Over time, the air pocket gradually increases in size, allowing the user to visually monitor its size and intuitively gauge the amount of water used.

Additionally, in the present invention, when water is sprayed from the front of the head unit, an air flow passage formed through the center of the head unit, connecting the front and rear, allows air to be drawn from the rear side of the head unit to the front, directing it in the same direction as the water spray.

Additionally, in the present invention, the cross-section of the grip tube, which the user holds, is formed in an elliptical shape, providing excellent grip comfort. The water conduit, formed inside the grip tube, is shaped in a perfectly circular form and is spaced apart from the grip tube with the pocket chamber in between, allowing for the smooth flow of water.

### BRIEF DESCRIPTION OF THE DRAWINGS

FIG. 1 is a perspective view showing the shower hose with the shower tap and inlet hole formed in the air-mixing showerhead of the present invention.

FIG. 2 is a perspective view of the entire shower body in the air-mixing showerhead of the present invention.

FIG. 3 is a cross-sectional perspective view of the lower part of the grip tube in the air-mixing showerhead of the present invention.

FIG. 4 is a cross-sectional view of the shower body in the air-mixing showerhead of the present invention.

FIG. 5 illustrates the interior of the grip tube in the air-mixing showerhead of the present invention: (a) shows the initial state where an air pocket is formed inside the pocket chamber, (b) shows the size of the air pocket inside the pocket chamber when the shower is used with an appropriate amount of water, and (c) shows the size of the air pocket inside the pocket chamber when the shower is used with an excessive amount of water.

FIG. 6 is a perspective view showing the head unit of the air-mixing showerhead in the present invention.

FIG. 7 is a front view showing the water flow inside the shower body of the air-mixing showerhead in the present invention.

FIG. 8 is a cross-sectional view showing the water flow inside the shower body of the air-mixing showerhead in the present invention.

FIG. 9 illustrates the air control ring in the air-mixing showerhead of the present invention: (a) is a perspective view, and (b) is a cross-sectional perspective view showing the state where it is placed inside the grip tube.

### DETAILED DESCRIPTION

Hereinafter, the preferred embodiment of the present invention will be described with reference to the attached drawings so that a person of ordinary skill in the art can easily implement it.

When using the shower body (10), it is typically positioned upright and oriented toward the user. Based on this state, the positions of each component will be described. When the shower body (10) is in an upright position, the upper part is referred to as the "top" and the lower part as the "bottom." The front refers to the side where the water is sprayed, while the rear refers to the opposite side. The "leading end" indicates the direction toward the shower tap (22) based on the direction of the water flow, and the "trailing end" indicates the direction toward the nozzle (241).

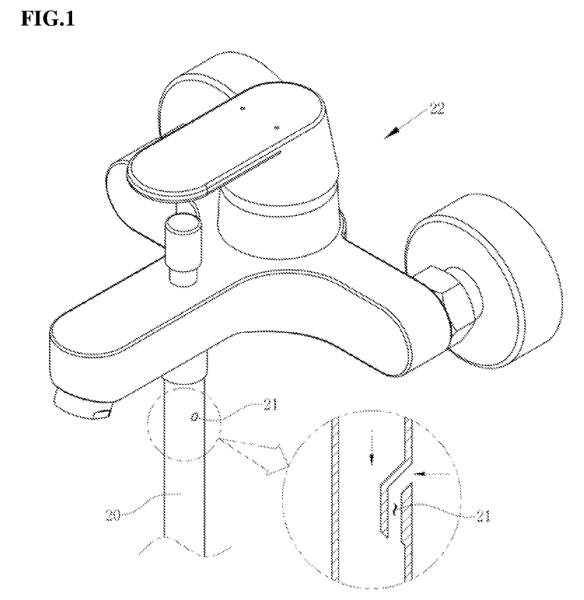

Referring to FIGS. 1 to 8, the air-mixing showerhead according to the present invention is designed to introduce air into the showerhead, mix it with water inside, and spray it, providing a refreshing impact on the user’s skin for a massaging effect. The showerhead introduces air through the inlet hole (21) into the shower hose (20). The grip tube (100) is equipped with a coupling hole (140) at its lower end, which connects to the shower hose (20). Inside this coupling hole (140), a conduit guide fin (130) is positioned to create a vortex flow of the water passing through the interior; The head unit (200) is formed as a hollow circular structure, connected to the grip tube (100), and contains a connecting port (210) that receives water from the interior of the grip tube (100). The head unit is also equipped with a spray plate (240) at the front, which has nozzles (241) for spraying the air-mixed water; additionally, at the center of the head unit (200), an air flow passage (230) is formed, with the sides sealed while the front and rear remain open. This allows air from the rear side of the head unit (200) to move to the front as water is sprayed through the nozzle (241). Consequently, the air passing through the grip tube (100) and the air passing through the air flow passage (230) mix at the front of the head unit (200).

The showerhead of the present invention is designed not only to spray water through the nozzle (241) but to introduce air, mix it with the water, and then spray the air-water mixture through the nozzle (241). This configuration allows the air-mixed water to provide a refreshing impact on the user's skin, delivering a massaging effect. Furthermore, during the mixing process, air bubbles are formed within the water, which effectively adhere to and cleanse impurities, dead skin cells, and other residues present on the skin, offering a powerful cleaning function.

The air is drawn into the interior of the shower hose (20) through an inlet hole (21) that connects the inside and outside of the shower hose (20), allowing both air and water to flow together along the shower hose (20). The inlet hole (21) may be formed directly on the shower hose (20), or it may be formed on the shower tap (22), which functions as the water control device. Alternatively, the inlet hole (21) could be positioned between the shower hose (20) and the shower tap (22), or a separate air intake device could be inserted by cutting the shower hose (20). The present invention allows the inlet hole to be placed at any location on the lower part of the shower body (10), and it is not limited to being installed on the shower hose (20) as shown in FIG. 1. However, for the sake of explanation, the inlet hole (21) is depicted as being formed on the shower hose (20).

At the connection point where the shower hose (20) and the shower body (10) meet, known as the coupling hole (140), water from the shower hose (20) flows into the shower body (10). At this point, the incline of the conduit guide fin (130), which is positioned inside the coupling hole (140), causes the water to swirl in a circular direction inside the grip tube (100), promoting the mixing of water and air.

The air-mixed water flows in a swirling motion, passes through the water conduit (110), and enters the head unit (200).

The water conduit (110) is spaced apart from the inner surface of the grip tube (100), creating a space between them called the pocket chamber (120). As the air-mixed water passes through the coupling hole (140), it is divided and flows into both the central chamber (111), which is the internal space of the water conduit (110), and the pocket chamber (120).

The central chamber (111) is connected to the head unit (200) through the connecting port (210), while the top of the pocket chamber (120) is sealed, preventing further flow. Among the water and air entering the pocket chamber (120), the air, which is less dense than the water, remains at the top, while the water flows back out of the pocket chamber (120) and returns to the central chamber (111). Consequently, the air stays in the pocket chamber (120), forming an air pocket (121). As more water is used with the showerhead, the amount of air accumulating in the pocket chamber (120) increases.

The user can visually check the air pocket (121) inside the pocket chamber (120) through the transparent grip tube (100), allowing them to intuitively gauge their water usage. This helps the user make efforts to conserve water.

The water and air that flow through the water conduit (110) and enter the head unit (200) via the connecting port (210) are directed by the head guide fin (220), which is a baffle-shaped structure positioned at the rear of the connecting port (210). This causes the flow to swirl along the circumference of the head unit (200). As a result, it prevents the air within the water from concentrating at the nozzles (241) close to the spray plate (240) and allows the air to be evenly distributed across the entire surface of the spray plate (240).

The air-mixed water is sprayed through the nozzles (241) of the spray plate (240) located at the front of the head unit (200), providing a refreshing impact on the user's skin and effectively cleansing impurities and residues with strong cleaning power.

As shown in FIG. 1, the showerhead according to the present invention draws air from outside the shower hose (20) into the interior of the shower hose (20) through the inlet hole (21). The inlet hole (21) can be positioned at any location along the shower hose (20), but it may also be formed at the connection point, such as the coupling bolt, where the shower tap (22) and the shower hose (20) are joined. Alternatively, it may be configured at the midpoint of the shower hose (20) using a semi-rigid material to allow air intake.

During water use, it is preferable that the water, after being discharged from the shower tap (22), flows along the shower hose (20) without being discharged through the inlet hole (21). Air from outside the shower hose (20) enters through the inlet hole (21), and if the water inside the shower hose (20) flows out through the inlet hole (21), it undermines the objective of water conservation in the present invention. The structure that prevents water from leaking out through the inlet hole (21) while allowing only air to flow in can follow prior art techniques; however, the diagram of one embodiment of the present invention omits this structure and shows only the inlet hole (21).

Additionally, when the shower is finished and water use has stopped, the residual water that remains inside the shower hose (20) and the shower body (10) is allowed to drain through the inlet hole (21). This enables the removal of any remaining water and prevents contamination or the formation of water stains.

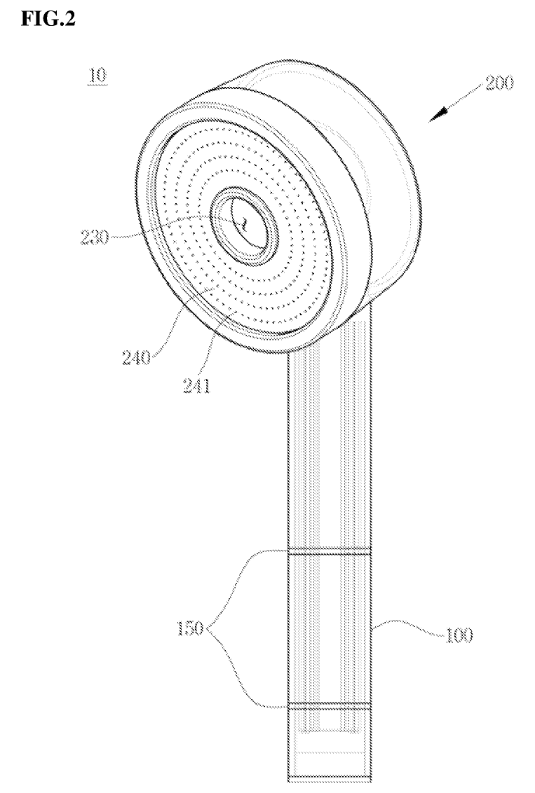

As shown in FIG. 1 and FIG. 2, one end of the shower hose (20) is connected to the shower tap (22), while the other end is connected to the shower body (10). The shower body (10) consists of the grip tube (100), which is the part that the user holds, and the head unit (200), which is the part from which water is sprayed. The grip tube (100) is formed as a long hollow conduit, while the head unit (200) is shaped as a round hollow circular structure.

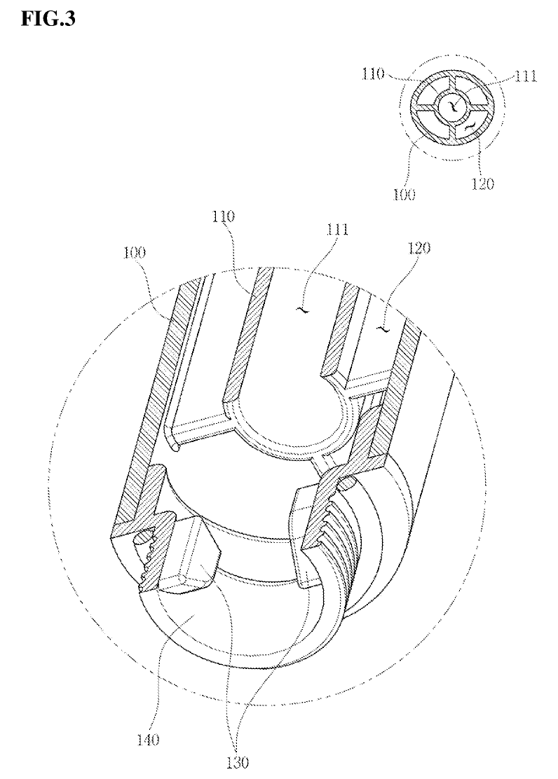

As shown in FIG. 3, the lower end of the grip tube (100) is equipped with a coupling hole (140), which is screw-connected and communicates with the shower hose (20). Water from the shower hose (20) flows into the interior of the grip tube (100) through the coupling hole (140). The upper end of the grip tube (100) is connected to the head unit (200), which will be described later

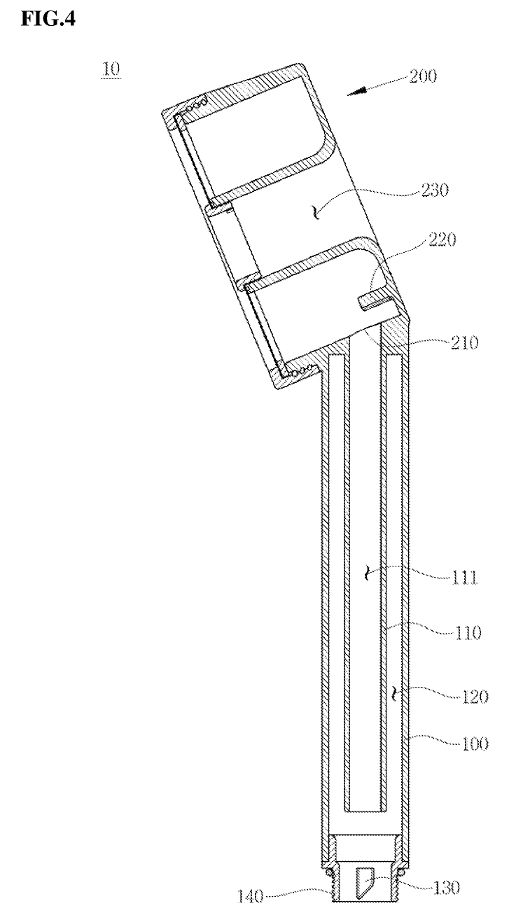

As shown in FIG. 4, the grip tube (100) is formed in a long tubular shape oriented vertically, allowing water to flow within its internal space. The grip tube (100) is shaped as an elliptical shape, with a gentle curvature on the front and rear sides, and a more pronounced curvature on the sides, providing an excellent grip for the user.

As shown in FIG. 3, the inner surface of the coupling hole (140) is formed with a conduit guide fin (130) that generates a vortex by directing the flow of water entering the interior of the grip tube (100) in a swirling motion. The surface of the conduit guide fin (130) that faces the incoming water into the grip tube (100) is inclined, adding rotational force to the direction of water flow.

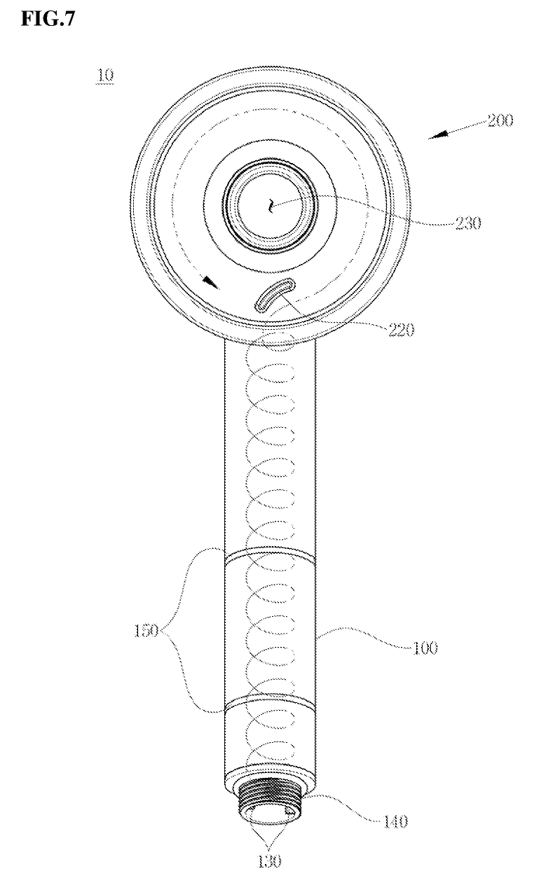

As shown in FIG. 7, the water, which has gained rotational force from the conduit guide fin (130), flows in a swirling motion within the grip tube (100), effectively removing any impurities that have settled inside the grip tube (100). Additionally, the newly incoming water also flows in a vortex, preventing water deposits from remaining inside the grip tube (100), thereby enhancing cleanliness.

Furthermore, in the present invention, when air is mixed with water and sprayed through the nozzle (241), it exerts a strong cleansing action on the skin through air bubbles while providing a refreshing impact for a massage effect. However, if the air in the water is unevenly distributed and concentrated on one side, the cleansing and massage effects may only occur in localized areas on the user's skin.

The air, which flows into the interior of the shower hose (20) through the inlet hole (21) and mixes with the water, creates a swirling motion inside the grip tube (100), promoting the mixing of air and water while ensuring that the air is evenly distributed within the water. As a result, when sprayed from the nozzle (241), the user experiences an even cleansing action and massage effect.

The conduit guide fin (130) can be provided as a single unit or in multiple units. Increasing the number of fins enhances the effect of forming a vortex flow of water; however, it also reduces the cross-sectional area within the coupling hole (140), which can affect the water flow rate. Therefore, in one embodiment of the present invention, two fins are provided.

As illustrated in FIGS. 3 and 4, a tubular water conduit (110) is formed inside the grip tube (100). The water conduit (110) is configured as a hollow, elongated tube, with its cross-sectional diameter being slightly smaller than that of the grip tube (100) and its length being slightly shorter than that of the grip tube (100).

The lower end of the water conduit (110) is open and communicates with the coupling hole (140), and the upper end is also open, allowing it to connect with the head unit (200). The portion of the open upper end of the water conduit (110) that contacts the head unit (200) is formed as a connecting port (210).

The outer surface of the water conduit (110) is spaced apart from the inner surface of the grip tube (100). Therefore, the space between the water conduit (110) and the grip tube (100) forms a pocket chamber (120). The upper end of the pocket chamber (120) is closed, making it difficult for the flow of water or air to proceed upward within the pocket chamber (120).

For convenience, the internal space of the water conduit (110) is referred to as the central chamber (111), and the space between the water conduit (110) and the grip tube (100) is referred to as the pocket chamber (120), as shown in FIG. 4. In other words, the internal space of the grip tube (100) can be divided into the central chamber (111) and the pocket chamber (120). The central chamber (111) is located at the center of the internal space of the grip tube (100), while the pocket chamber (120) is situated at the edges.

The top and bottom of the central chamber (111) are open, allowing air and water to flow in and out, while the bottom of the pocket chamber (120) is open, permitting water to enter and exit, but the top is sealed, preventing fluid flow. The pocket chamber (120) is enclosed on all sides except for its open bottom. Water and air enter through the open bottom of the pocket chamber (120), and the water then exits again through the bottom.

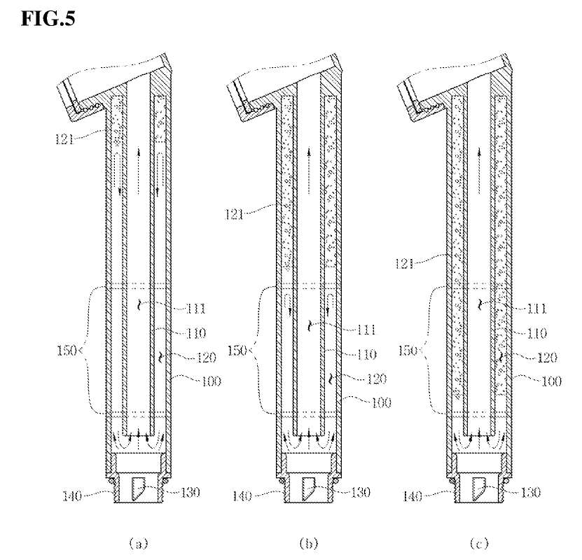

Referring to FIG. 5, the water containing air passes through the coupling hole (140) and is then divided by the lower part of the water conduit (110), with most of it entering the central chamber (111) and some entering the pocket chamber (120). When the water containing air enters the central chamber (111), it moves along the length of the water conduit (110) and passes through the connecting port (210) to enter the head unit (200).

Some of the water that enters the pocket chamber (120) moves upward but is blocked at the top, preventing further movement. Consequently, it flows back down through the pocket chamber (120) and re-enters the central chamber (111), eventually proceeding to the head unit (200).

At this time, the air contained in the water has a lower density than the water, causing it to move upward. As the water at the top of the pocket chamber (120) descends and flows back down through the pocket chamber (120), the air, due to its buoyancy, remains at the top of the pocket chamber (120) and does not descend.

As water continues to flow and the shower runs continuously, water containing air is constantly introduced into the pocket chamber (120) through the coupling hole (140). While the water exits the pocket chamber (120), the air cannot escape and continues to accumulate. The more the water is used, the more an air pocket (121) forms at the top of the pocket chamber (120), due to the continuous inflow of air through the inlet hole (21) provided at the front end of the grip tube (100).

As the amount of water used during the shower increases, the size of the air pocket (121) also gradually grows in proportion, allowing the user to gauge the amount of water used based on the size of the air pocket (121). The vertical length of the air pocket (121) increases over time as water flows into the grip tube (100), causing the water level in the pocket chamber (120) to decrease. To allow the user to check the air pocket (121), the grip tube (100) is made of a transparent material that allows light to pass through, making the water level in the pocket chamber (120) visible.

The air pocket (121) remains at the top of the pocket chamber (120), but as it grows in size, it gradually moves downward, causing the water level in the pocket chamber (120) to decrease, as shown in FIG. 5. As the water usage increases, the water level in the pocket chamber (120) continues to drop, allowing the user to gauge the amount of water used at a specific height of the grip tube (100) through the water usage indicator (150).

The water usage indicator (150) is displayed at a specific height on the grip tube (100), either as a single marker or in multiples. When the water usage indicator (150) is displayed as a single marker, it indicates the appropriate level corresponding to the amount of water used during the shower. If multiple markers are provided, additional indicators can be displayed at specific heights to alert the user of excessive water use. For example, as shown in FIG. 2, the upper part of the water usage indicator (150) may display "Normal," while the lower part may display "Excessive." The user can easily recognize that they have used an average amount of water when the bottom of the air pocket (121) aligns with the "Normal" indicator. Conversely, if the bottom of the air pocket (121) aligns with the "Excessive" indicator, the user can intuitively understand that a large amount of water has been used during the shower. This feature of the invention helps encourage water conservation during showers.

Thus, the user can intuitively monitor the amount of water used by continuously observing the increasing size of the air pocket (121) and the decreasing water level in the pocket chamber (120) through the water usage indicator (150). This helps the user become aware of their water usage and encourages efforts to conserve water.

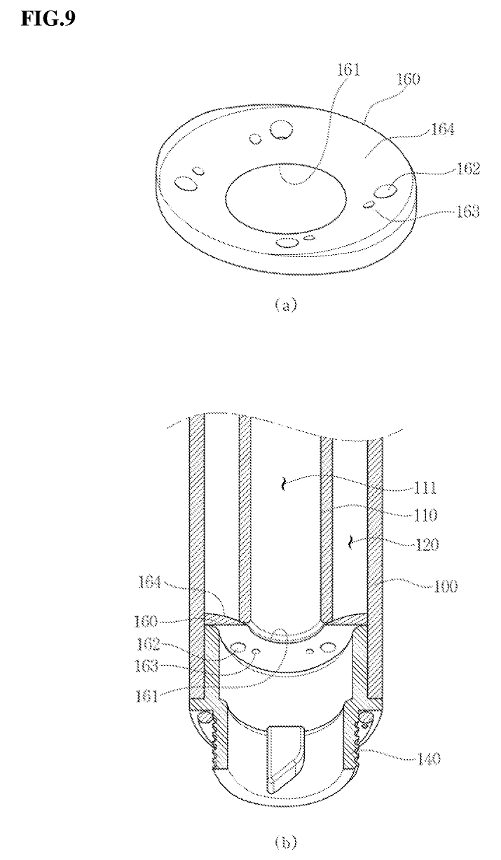

As shown in FIG. 9, an air control ring (160) may be further positioned at the rear end of the coupling hole (140). The air control ring (160) is formed in a donut shape with a central hole (161) in its middle. The central hole (161) is designed to correspond to the water conduit (110). Specifically, the diameter and shape of the central hole (161) are formed to match those of the water conduit (110), allowing the fluid (water and air) passing through the central hole (161) to flow into the central chamber (111).

The air control ring (160) is positioned to seal the open bottom of the pocket chamber (120). The air control ring (160) includes a large hole (162) and a small hole (163) with a smaller diameter than the large hole (162), formed for each pocket chamber (120). The fluid (water and air) enters the pocket chamber (120) through the large hole (162), and the amount of fluid entering the pocket chamber (120) varies depending on the size of the large hole (162). The size of the large hole (162) is determined to suit the internal volume of the pocket chamber (120) to ensure that the amount of air filling the chamber does not increase too rapidly. In one embodiment, after 12 minutes have passed from the start of the shower (when water begins to be discharged from the shower body (10)), the bottom of the air pocket (121) in the pocket chamber (120) is positioned near the "Normal" level of the water usage indicator (150). After 18 minutes, it is positioned near the "Excessive" level of the water usage indicator (150).

The upper surface of the air control ring (160) is formed as a sloped surface (164) that inclines downward toward the central hole (161). When the shower is turned off and the shower body (10) is hung up, the residual water inside the shower body (10) is guided inward toward the central hole (161) along the sloped surface (164) and is drained from the pocket chamber (120) through the large hole (162). The large hole (162) can be positioned adjacent to the central hole (161), allowing the water collected along the sloped surface (164) to drain inward toward the central hole (161) through the large hole (162) located near the central hole (161)..

The small hole (163) serves as an air passage that allows the water remaining inside the pocket chamber (120) to be easily drained through the large hole (162) when the water usage through the shower body (10) is stopped, and the water inside the shower body (10) flows back to the front end through the inlet hole (21) for drainage. Therefore, the small hole (163) can be formed with a small size, sufficient for air to pass through.

The volume of the pocket chamber (120) can be formed smaller than that of the central chamber (111). The function of the pocket chamber (120) is to serve as a chamber that informs the user of the water usage through the air pocket (121). Since it does not need to accommodate a large amount of fluid, it is preferable that the volume of the pocket chamber (120) be smaller than that of the central chamber (111).

As shown in FIG. 4, the water conduit (110) and the grip tube (100) are arranged with the pocket chamber (120) in between. Therefore, the grip tube (100) is formed in an elliptical shape for superior grip, while the water conduit (110) is formed in a perfectly circular form to allow efficient water flow. The pocket chamber (120) acts as a buffer space between the elliptical-shaped grip tube (100) and the perfectly circular form of the water conduit (110), achieving both advantages of improved grip and efficient water flow.

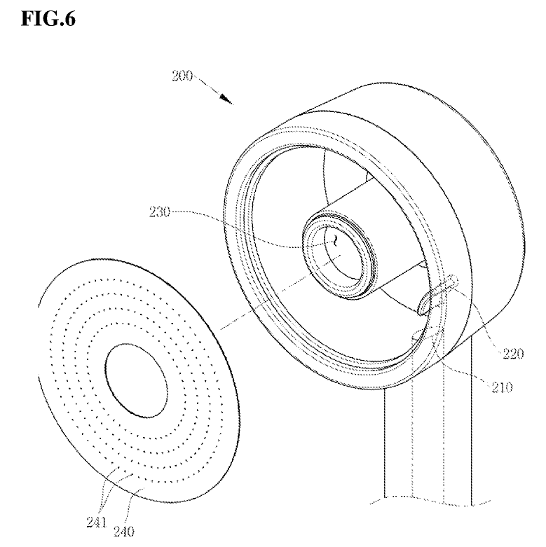

As shown in FIG. 6, the head unit (200), which is coupled with the grip tube (100), is configured to spray both water and air. It has a hollow interior and is formed in a circular shape.

The head unit (200) is coupled with the grip tube (100) in such a way that its hollow interior does not communicate with the pocket chamber (120) but rather communicates with the central chamber (111). The internal space of the head unit (200) and the central chamber (111) are connected through the connecting port (210).

A partition-shaped head guide fin (220) is positioned at the rear end of the connecting port (210). The head guide fin (220) is designed to guide the flow of water entering the head unit (200) through the connecting port (210) in a swirling vortex pattern.

The head guide fin (220) protrudes from the inner rear surface of the head unit (200) toward the front and is rounded to direct the flow of water to one side. The water ejected through the connecting port (210) hits the head guide fin (220), and as the flow is redirected along the rounded shape of the head guide fin (220), it creates a swirling vortex flow in the circumferential direction of the head unit (200).

As shown in FIG. 7, the conduit guide fin (130) creates a swirling vortex flow, mixing water and air. This is followed by another vortex flow induced by the head guide fin (220) in the head unit (200), further promoting the mixing of water and air. The vortex flow generated in the head unit (200) helps prevent the adhesion of water stains and foreign substances on the inner wall surface of the head unit (200).

Although a vortex flow occurs inside the grip tube (100), the diameter of the vortex flow within the grip tube (100) is smaller than the diameter of the vortex flow generated in the head unit (200). Therefore, by forming a larger diameter vortex flow in the head unit (200) compared to that in the grip tube (100), water and air can be mixed more uniformly and effectively.

Additionally, since the water mixed with air circulates within the internal space of the head unit (200) due to the head guide fin (220), it prevents air from being concentrated and sprayed through the nozzle (241) near the connecting port (210). This allows air to be uniformly distributed and sprayed through all the nozzles (241) of the spray plate (240).

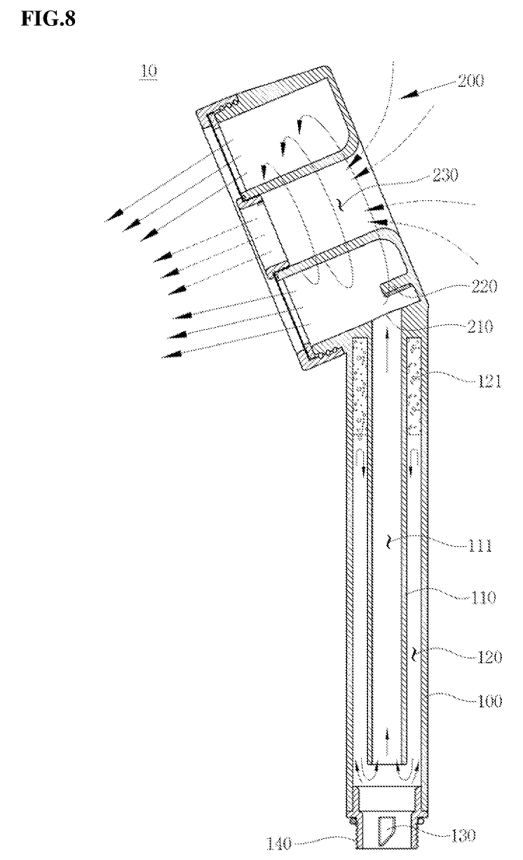

As shown in FIGS. 6 and 8, an air flow passage (230) is formed at the center of the head unit (200). The air flow passage (230) serves as a channel through which air from the external space of the head unit (200) flows. Air from the rear side of the head unit (200) exterior moves through the air flow passage (230) to the front side of the head unit (200), where the water is sprayed.

The air flow passage (230) is open at both the front and rear, with its sides enclosed like a cylinder. Due to the structure of the air flow passage (230), the head unit (200) is formed in a donut shape with an empty center.

When water and air are sprayed through the nozzle (241) of the spray plate (240), the front side of the head unit (200) becomes a low-pressure area due to the velocity of the fluid, and the space extended by the air flow passage (230) toward the front side also becomes a low-pressure area. As a result, the fluid (water and air) sprayed from the nozzle (241) of the spray plate (240) converges toward the central axis, causing the water stream to become more concentrated and stronger.

Additionally, the rear side of the external space of the head unit (200), which has a relatively higher pressure than the front side of the head unit (200), draws air through the air flow passage (230) and moves it to the front side of the head unit (200).

As water is sprayed, the pressure difference between the front and rear sides of the head unit (200) draws in air, adding a sense of impact from the air, which enhances the massaging effect on the user’s skin.

The flow of water and air (fluid) in the air-mixing shower head according to an embodiment of the present invention is described.

When the shower tap (22) is turned on for a shower, water flows through the shower hose (20), and air from outside the shower hose (20) enters its interior through the inlet hole (21).

As air and water enter the interior of the shower body (10) through the coupling hole (140), the conduit guide fin (130) creates a swirling vortex flow, ensuring that the water and air are uniformly mixed.

Then, the fluid (water and air) flows in a swirling motion and is divided, entering both the central chamber (111) and the pocket chamber (120). The fluid that enters the central chamber (111) flows into the head unit (200) through the connecting port (210).

Referring to FIG. 5, the water in the fluid that enters the pocket chamber (120) is pushed back by the blocked top of the pocket chamber (120) and re-enters the central chamber (111), while the air, having a lower density than water, remains in the pocket chamber (120), forming an air pocket (121). As water continues to be used, the size of the air pocket (121) in the pocket chamber (120) gradually increases, and the water level in the pocket chamber (120) decreases.

The user can intuitively check the size of the air pocket (121) and the water level through the water usage indicator(s) (150), which may be provided as a single or multiple markers, allowing them to monitor how much water has been used.

The fluid that enters the head unit (200) passes through the connecting port (210) and strikes the head guide fin (220), creating a vortex in the circumferential direction of the head unit (200). Since the vortex diameter in the head unit (200) is larger than the vortex diameter inside the grip tube (100), the water and air are further mixed before being sprayed from the nozzle (241) of the spray plate (240).

Additionally, the air mixed within the water is prevented from concentrating at the nozzles (241) of the spray plate (240) that are closest to the connecting port (210). Instead, it is evenly distributed and sprayed through all the nozzles (241).

When water and air are sprayed from the nozzle (241) of the spray plate (240), the velocity of the fluid creates a low-pressure area on the front side of the head unit (200). This causes the air from the rear side of the head unit (200) to move through the air flow passage (230) to the front side, where it is directed onto the user’s skin along with the water stream. On the front side of the head unit (200), the air that passed through the grip tube (100) and the air that passed through the air flow passage (230) are combined.

The pressure difference between the front and rear sides of the head unit (200) causes the water stream to be concentrated in the space extended by the air flow passage (230) toward the front side, delivering a strong impact sensation to the skin.

Additionally, as the fluid moves in a swirling vortex flow within the grip tube (100) and the head unit (200), it helps prevent the buildup of water stains and foreign substances. [0113] After the shower is finished and the water is turned off, the remaining water inside the shower hose (20) and the shower body (10) is discharged through the inlet hole (21), ensuring cleanliness.

### DESCRIPTION OF S YMBOLS

10:shower body

20:shower hose

21:inlet hole

22:shower tap

100:grip tube

110:water conduit

111:central chamber

120:pocket chamber

121:air pocket

130:conduit guide fin

140:coupling hole

150:water usage indicator

160:air control ring

161:central hole

162:large hole

163:small hole

164: sloped surface

200:head unit

210:connecting port

220:head guide fin

230:air flow passage

240:spray plate

241:nozzle

1. An air-mixing shower head structure, comprising:
A shower hose (20);
An inlet hole (21) is configured to allow air to enter interior of the shower hose (20);
A grip tube (100) is equipped with a coupling hole (140) at its lower end, which connects to the shower hose (20). Inside this coupling hole (140), a conduit guide fin (130) is positioned to create a vortex flow of the water passing through the interior; and
A head unit (200) is formed as a hollow circular structure and connected to the grip tube (100), includes a connecting port (210) that receives water from inside the grip tube (100) and is provided with a spray plate (240) at the front, through which water mixed with air is sprayed via the nozzle (241);
An air flow path (230) is formed at the center of the head unit (200), which is sealed on the sides and open at the front and rear, allowing air from the rear of the head unit (200) to flow to the front as water is sprayed through the nozzle (241), so that the air passing through the grip tube (100) and the air passing through the air flow path (230) mix at the front of the head unit (200);
wherein the grip tube (100) includes a central chamber (111), which is the internal space of the water conduit (110) vertically positioned within the grip tube(100), and the central chamber is open at the bottom, connecting with the coupling hole (140), and open at the top, linking to the head unit (200);
wherein the grip tube (100) includes a pocket chamber (120), which is formed as the space created by separation between the inner surface of the grip tube (100) and the water conduit (110), the pocket chamber (120) is open at the bottom, connecting with the coupling hole (140), and sealed at the top;
wherein the coupling hole (140) allows the air-mixed water to pass through and branch into the central chamber (111) and the pocket chamber (120);
wherein the pocket chamber (120) allows some of the water entering it to flow downwards to the lower part of the pocket chamber (120), leaving an air pocket (121) at the top of the pocket chamber (120),
wherein the air pocket (121) gradually increases in vertical length over time as water enters the grip tube (100), resulting in a lowering of the water level within the pocket chamber (120).

2. the air-mixing shower head structure of claim 1, wherein the connecting port (210) includes a curved partition-shaped head guide fin (220) formed at its rear end, causing the water that hits the head guide fin (220) to flow in the circumferential direction inside the head unit (200).

3. the air-mixing shower head structure of claim 1,wherein the grip tube (100) is made of a transparent material, exposing the water level inside the pocket chamber (120),and a single or multiple water usage indicators (150) are displayed at specific heights on the grip tube (100).

4. the air-mixing shower head structure of claim 1, wherein the grip tube (100) has an elliptical cross-section and the water conduit (110), which is spaced apart from the grip tube (100) with the pocket chamber (120) in between, has a perfectly circular cross-section.

5. the air-mixing shower head structure of claim 2, wherein a diameter of the vortex created by the fluid inside the head unit (200) is larger than the diameter of the vortex created by the fluid inside the grip tube (100).

6. the air-mixing shower head structure of claim 1,further comprising an air control ring (160) that is positioned to seal the open bottom of the pocket chamber (120), with a central hole (161) corresponding to the water conduit (110) formed at its center, and a large hole (162) allowing fluid to enter and exit the pocket chamber, as well as a small hole (163) with a smaller diameter than the large hole.
